(19) United States
(12) Patent Application Publication
(10) Pub. No.: US 2015/0306822 A1
(43) Pub. Date: Oct. 29, 2015

(54) METHOD OF MANUFACTURING THREE-DIMENSIONAL STRUCTURE, THREE-DIMENSIONAL STRUCTURE, THREE-DIMENSIONAL STRUCTURE MANUFACTURING APPARATUS, THREE-DIMENSIONAL FORMATION COMPOSITION, AND THREE-DIMENSIONAL FORMATION MATERIAL

(71) Applicant: Seiko Epson Corporation, Tokyo (JP)

(72) Inventor: Koki HIRATA, Matsumoto (JP)

(21) Appl. No.: 14/694,327

(22) Filed: Apr. 23, 2015

(30) Foreign Application Priority Data
Apr. 24, 2014 (JP) 2014-090624

(51) Int. Cl. B29C 67/00

(52) U.S. Cl. CPC B29C 67/0081; B29L 2031/772

(57) ABSTRACT

Provided is a method of manufacturing a three-dimensional structure, in which the three-dimensional structure is manufactured by laminating a layer, the method including: forming the layer using a three-dimensional formation composition containing a particle whose surface is hydrophobically treated and has at least one reactive group selected from the group consisting of an acrylic group, a methacrylic group, a vinyl group, a styryl group, and an isocyanate group; and discharging a curable ink containing monofunctional and/or difunctional (meth)acrylate onto the layer.

### BACKGROUND

1. Technical Field

The present invention relates to a method of manufacturing a three-dimensional structure, a three-dimensional structure, a three-dimensional structure manufacturing apparatus, a three-dimensional formation composition, and a three-dimensional formation material.

2. Related Art

A technology of forming a three-dimensional object while hardening powder with a binding solution is known (for example, refer to JP-A-6-218712). In this technology, a three-dimensional object is formed by repeating the following operations. First, powder is thinly spread in a uniform thickness to form a powder layer, and a binding solution is discharged to a desired portion of the powder layer to bind the powder particles together. As a result, in the powder layer, only the portion to which the binding solution is discharged is attached to form a thin plate-like member (hereinafter referred to as “section member”). Thereafter, a thin powder layer is further formed on this powder layer, and a binding solution (curable ink) is discharged to a desired portion thereof. As a result, a new section member is formed even on the portion of the newly-formed powder layer to which the binding solution is discharged. In this case, since the binding solution discharged on the powder layer penetrates the powder layer to reach the previously-formed section member, the newly-formed section member is attached to the previously-formed section member. The thin plate-like section members are laminated one by one by repeating these operations, thus forming a three-dimensional object.

In this technology for forming a three-dimensional object, when three-dimensional shape data of an object to be formed exists, it is possible to directly form a three-dimensional object by binding powder, and it is possible to quickly and inexpensively form a three-dimensional object because there is no need to create a mold prior to forming. In addition, since the three-dimensional object is formed by laminating the thin plate-like section members one by one, for example, even in the case of a complex object having an internal structure, it is possible to form the three-dimensional object as an integrally-formed structure without dividing the complex object into a plurality of parts.

However, in the related art, a binding solution cannot exhibit sufficiently high binding force, and thus the strength of a three-dimensional structure could not be made to be sufficiently high.

### SUMMARY

An advantage of some aspects of the invention is to provide a method of manufacturing a three-dimensional structure, by which a three-dimensional structure having excellent mechanical strength can be efficiently manufactured, a three-dimensional structure having excellent mechanical strength, a three-dimensional structure manufacturing apparatus, by which a three-dimensional structure having excellent mechanical strength can be efficiently manufactured, a three-dimensional formation composition, and a three-dimensional formation material.

The invention is realized in the following forms.

According to an aspect of the invention, there is provided a method of manufacturing a three-dimensional structure, in which the three-dimensional structure is manufactured by laminating a layer, the method including: forming the layer using a three-dimensional formation composition containing a particle whose surface is hydrophobically treated and has at least one reactive group selected from the group consisting of an acrylic group, a methacrylic group, a vinyl group, a styryl group, and an isocyanate group; and discharging a curable ink containing monofunctional and/or difunctional (meth)acrylate to the layer.

In this case, it is possible to provide a method of manufacturing a three-dimensional structure, by which a three-dimensional structure having excellent mechanical strength can be efficiently manufactured.

In the method of manufacturing a three-dimensional structure according to the aspect of the invention, it is preferable that the reactive group of the surface of the particle is a functional group introduced by a silane coupling agent.

In this case, it is possible to more easily introduce the reactive group into the surface of the particle.

In the method of manufacturing a three-dimensional structure according to the aspect of the invention, it is preferable that the particle is an inorganic particle.

In this case, it is possible to further increase the mechanical strength of a three-dimensional structure to be finally obtained.

In the method of manufacturing a three-dimensional structure according to the aspect of the invention, it is preferable that the particle is made of any one selected from the group consisting of silica, calcium carbonate, alumina, and titanium dioxide.

In this case, it is possible to further increase the mechanical strength of a three-dimensional structure to be finally obtained.

In the method of manufacturing a three-dimensional structure according to the aspect of the invention, it is preferable that the three-dimensional formation composition contains a water-soluble resin.

In this case, it is possible to particularly increase the mechanical strength of a three-dimensional structure to be finally obtained.

According to another aspect of the invention, there is provided a three-dimensional structure, which is manufactured by the method of manufacturing a three-dimensional structure.

In this case, it is possible to provide a three-dimensional structure having excellent mechanical strength.

According to still another aspect of the invention, there is provided a three-dimensional structure manufacturing apparatus, in which the three-dimensional structure is manufactured by laminating a layer, the apparatus including: a layer formation unit that forms the layer using a three-dimensional formation composition containing a particle whose surface is hydrophobically treated and has at least one reactive group selected from the group consisting of an acrylic group, a methacrylic group, a vinyl group, a styryl group, and an isocyanate group; and an ink discharge unit that discharges a curable ink containing monofunctional and/or difunctional (meth)acrylate onto the layer.

In this case, it is possible to provide a three-dimensional structure manufacturing apparatus, by which a three-dimensional structure having excellent mechanical strength can be efficiently manufactured.

According to still another aspect of the invention, there is provided a three-dimensional formation composition, including: a particle whose surface is hydrophobically treated and has at least one reactive group selected from the group consisting of an acrylic group, a methacrylic group, a vinyl group, a styryl group, and an isocyanate group.

In this case, it is possible to more efficiently manufacture a three-dimensional structure having excellent mechanical strength.

According to still another aspect of the invention, there is provided a three-dimensional formation material, including: a three-dimensional formation composition containing a particle whose surface is hydrophobically treated and has at least one reactive group selected from the group consisting of an acrylic group, a methacrylic group, a vinyl group, a styryl group, and an isocyanate group; and a curable ink containing monofunctional and/or difunctional (meth)acrylate.

In this case, it is possible to more efficiently manufacture a three-dimensional structure having excellent mechanical strength.

### BRIEF DESCRIPTION OF THE DRAWINGS

The invention will be described with reference to the accompanying drawings, wherein like numbers reference like elements.

FIGS. 1A to 1D are schematic views showing each process of a preferred embodiment in the method of manufacturing a three-dimensional structure of the invention.

FIGS. 2A to 2D are schematic views showing each process of a preferred embodiment in the method of manufacturing a three-dimensional structure of the invention.

FIG. 3 is a cross-sectional view schematically showing the state in a layer (three-dimensional formation composition) immediately before an ink discharge process.

FIG. 4 is a cross-sectional view schematically showing the state in which particles are bound together by curable ink.

FIG. 5 is a perspective view showing the shape of a three-dimensional structure (three-dimensional structure A) manufactured in each of Examples and Comparative Examples.

FIG. 6 is a perspective view showing the shape of a three-dimensional structure (three-dimensional structure B) manufactured in each of Examples and Comparative Examples.

FIG. 7 is a plan view showing a preferred embodiment of the three-dimensional structure manufacturing apparatus of the invention.

FIG. 8 is a cross-sectional view of the three-dimensional structure manufacturing apparatus, which is seen from the right direction of FIG. 7.

### DESCRIPTION OF EXEMPLARY EMBODIMENTS

Hereinafter, preferred embodiments of the invention will be described in detail with reference to the accompanying drawings.

### 1. Method of Manufacturing Three-Dimensional Structure

First, the method of manufacturing a three-dimensional structure according to the invention will be described.

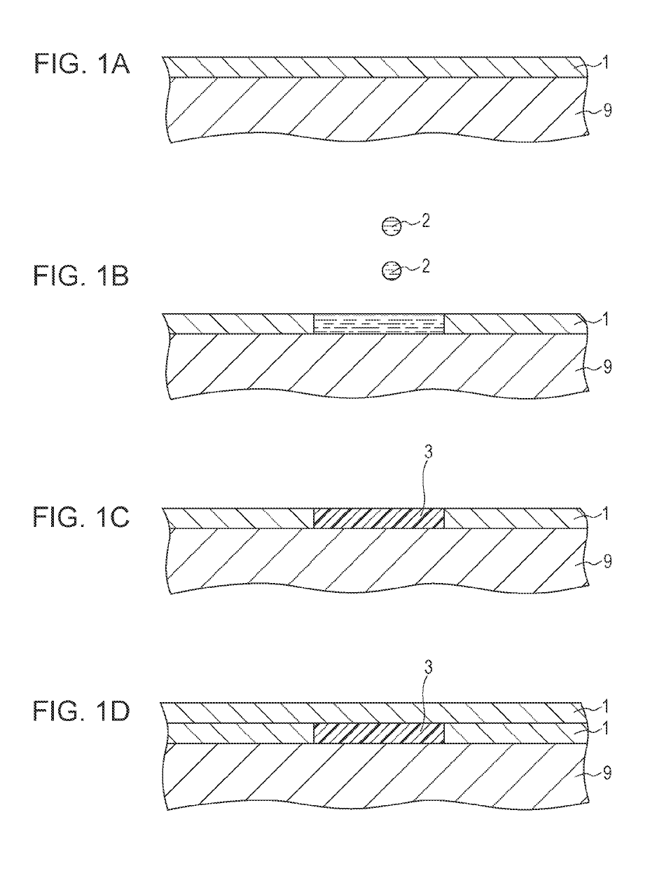

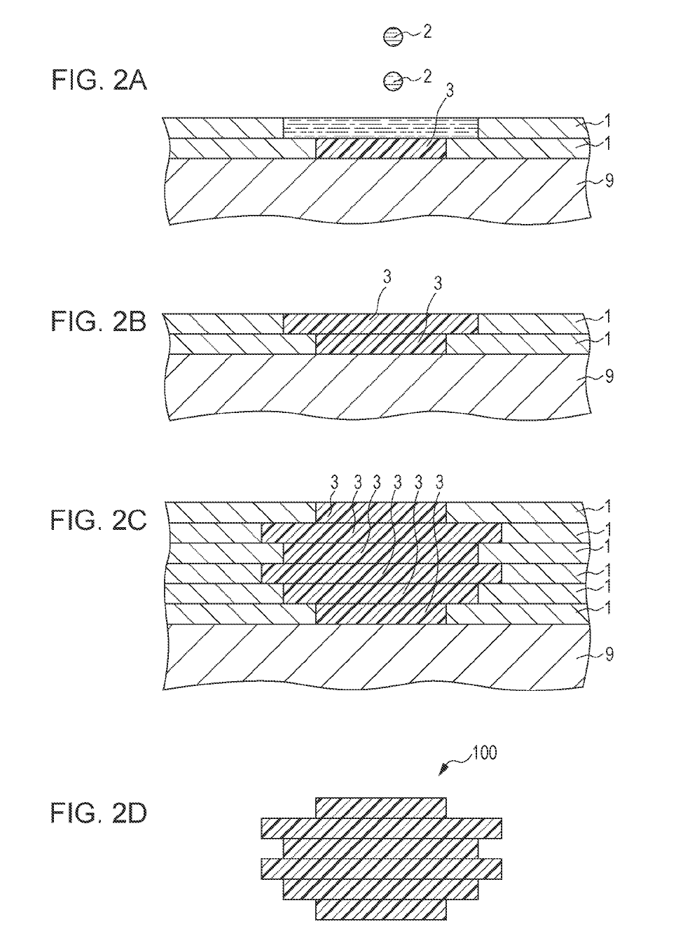

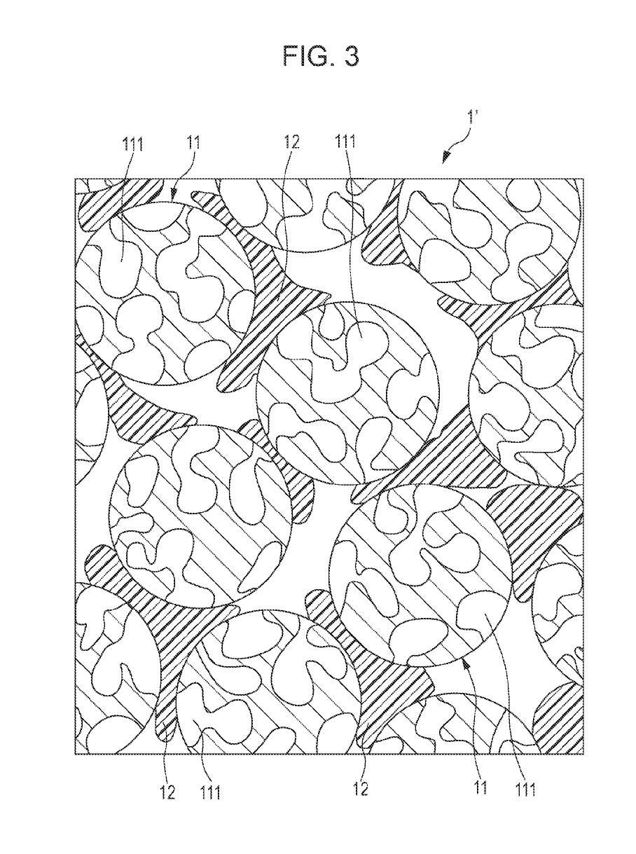

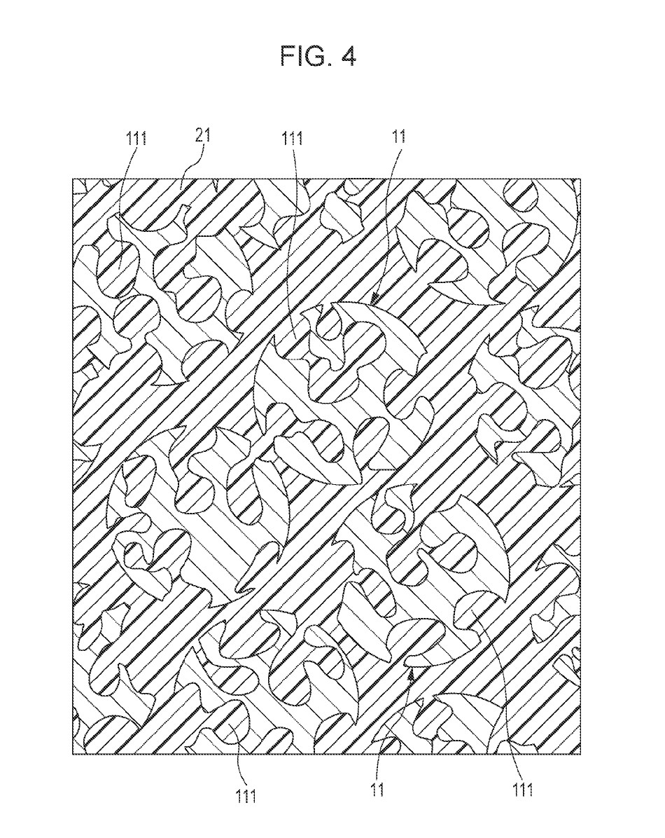

FIGS. 1A to 2D are schematic views showing each process of a preferred embodiment in the method of manufacturing a three-dimensional structure of the invention. FIG. 3 is a cross-sectional view schematically showing the state in a layer (three-dimensional formation composition) immediately before an ink discharge process. FIG. 4 is a cross-sectional view schematically showing the state in which particles are bound together by curable ink.

As shown in FIGS. 1A to 2D, the method of manufacturing a three-dimensional structure according to the present embodiment includes: layer forming processes (1A and 1D) of forming layers 1 using a three-dimensional formation composition 1′; ink discharge processes (1B and 2A) of applying a curable ink 2 containing a ultraviolet curable resin to each of the layers 1 by an ink jet method; and curing processes (1C and 2B) of curing the curable resin 21 contained in the curable ink 2 applied to each of the layers 1. Here, these processes are sequentially repeated. The method of manufacturing a three-dimensional structure further includes an unbound particle removal process (2D) of removing particles, which are not bound by the curable resin 21, from the particles 11 constituting each of the layers 1.

### Layer Forming Process

First, a layer 1 is formed on a support (stage) 9 using a three-dimensional formation composition 1′ (1A).

The support 9 has a flat surface (site on which the three dimension formation composition 1′ is applied). Thus, it is possible to easily and reliably form a layer 1 having highly uniform thickness.

It is preferable that the support 9 is made of a high-strength material. Various kinds of metal materials, such as stainless steel and the like, are exemplified as the constituent material of the support 9.

In addition, the surface (site on which the three-dimensional formation composition 1′ is applied) of the support 9 may be surface-treated. Thus, it is possible to effectively prevent the constituent material of the three-dimensional formation composition 1′ or the constituent material of the curable ink 2 from adhering to the support 9, and it is also possible to realize the stable production of a three-dimensional structure 100 over a long period of time by making the durability of the support 9 particularly excellent. As the material used in the surface treatment of the support 9, a fluorine-based resin, such as polytetrafluoroethylene, is exemplified.

The three-dimensional formation composition 1′ contains a particle 11 whose surface is hydrophobically treated and has at least one reactive group selected from the group consisting of an acrylic group, a methacrylic group, a vinyl group, a styryl group, and an isocyanate group. When the surface of the particle 11 is hydrophobically treated, the affinity of the particle to curable ink 2 to be described later can be improved, and the adhesiveness between the curable ink 2 and the particle 11 can be improved. Further, when the particle 11 has such a reactive group on the surface thereof, it is possible to chemically bond the particle 11 with curable ink 2 to be described later. As a result, it is possible to increase the mechanical strength of a three-dimensional structure 100 to be obtained.

Further, it is preferable that the three-dimensional formation composition 1′ contains a water-soluble resin 12. In this case, the particles 11 are bound (temporarily fixed) together (refer to FIG. 3) to effectively prevent the involuntary scattering of the particles 11. Thus, it is possible to improve the safety of workers or the dimensional accuracy of the three-dimensional structure 100 manufactured.

This process can be performed using a squeegee method, a screen printing method, a doctor blade method, a spin coating method, or the like.

The thickness of the layer 1 formed in this process is not particularly limited, but is preferably 30 μm to 500 μm, and more preferably 70 μm to 150 μm. Thus, the productivity of the three-dimensional structure 100 can be sufficiently increased, the occurrence of involuntary unevenness in the manufactured three-dimensional structure 100 can be more effectively prevented, and the dimensional accuracy of the three-dimensional structure 100 can be particularly increased.

### Ink Discharge Process

Thereafter, a curable ink 2 containing a curable resin 21 composed of monofunctional and/or difunctional (meth)acrylate is discharged onto the layer 1 by an ink jet method (1B).

In this process, the curable ink 2 is selectively applied only to the site corresponding to the real part (substantial site) of the three-dimensional structure 100 in the layer 1.

Thus, the particles 11 constituting the layer 1 can be strongly bound together by the curable resin 21, and therefore, the mechanical strength of the three-dimensional structure 100 to be finally obtained can be increased. More specifically, in the invention, the above-described reactive group of the surface of the particle 11 reacts with the (meth)acrylate, and thus the curable ink 2 and the particles 11 can be chemically bonded. As a result, it is possible to increase the mechanical strength of the three-dimensional structure 100 to be obtained.

Meanwhile, when porous particles are used as the particles 11, the curable resin 21 permeates into the holes 111 of the particles 11, thus exhibiting an anchor effect. As a result, the binding force between the particles 11 (binding force therebetween through the curable resin 21) can be increased, and thus it is possible to increase the mechanical strength of the three-dimensional structure 100 to be finally obtained (refer to FIG. 4). Further, the curable resin 21 constituting the curable ink 2 applied in this process permeates into the holes 111 of the particles 11, and thus it is possible to effectively prevent the involuntary wetting and spreading of ink.

In this process, since the curable ink 2 is applied by an ink jet method, the curable ink 2 can be applied with good reproducibility even when the pattern of the applied curable ink 2 is fine. As a result, together with the effect of the curable resin 21 permeating into the holes 111 of the particle 11, the dimensional accuracy of the three-dimensional structure 100 to be finally obtained can be particularly increased.

Meanwhile, the curable ink 2 will be described in detail later.

### Curing Process

Next, the curable resin 21 applied on the layer 1 is cured to form a cured portion 3 (1C). Approximately simultaneously with the curing of the curable resin 21, the above-described reactive group of the surface of the particle 11 reacts with the (meth)acrylate. Thus, binding strength between the particles 11 can be made to be particularly excellent, and, as a result, the mechanical strength of the three-dimensional structure 100 to be finally obtained can be made to be particularly excellent.

The ink discharge process and the curing process may be simultaneously performed. That is, the curing reaction may sequentially proceed from the site on which the curable ink 2 is applied, before the entire pattern of the layer 1 is formed.

Thereafter, a series of the processes are repeated (refer to 1D, 2A, and 2B). Thus, in each of the layers 1, the particles 11 are bound on the site on which the curable ink 2 has been applied, and, in this state, a three-dimensional structure 100 is obtained as a laminate in which the plurality of layers 1 are laminated (refer to 2C).

In the second and subsequent ink discharge processes (refer to 1D), the curable ink 2 applied to the layer 1 is used in binding the particles 11 constituting this layer 1, and a part of the applied curable ink 2 penetrates into the layer 1 located under this layer 1. For this reason, the curable ink 2 is used in binding the particles 11 between adjacent layers as well as in binding the particles 11 in each of the layers 1. As a result, the three-dimensional structure 100 finally obtained becomes excellent in overall mechanical strength.

### Unbound Particle Removal Process

After the aforementioned series of processes are repeated, in the particles 11 constituting each of the layers 1, a process (2D) of removing the particles (unbound particles) not bound by the curable resin 21 is performed. Thus, a three-dimensional structure 100 is taken out.

Examples of specific methods used in this process include a method of dispelling unbound particles with a brush or the like, a method of removing unbound particles by suction, a method of blowing a gas such as air, a method of imparting a liquid such as water (for example, a method of dipping the laminate obtained as described above into liquid, a method of spraying liquid, or the like), and a method of imparting vibration such as ultrasonic vibration thereto. These methods can be used in a combination of two or more thereof. More specifically, a method of blowing a gas such as air and then dipping the laminate into a liquid such as water and a method of imparting vibration such as ultrasonic vibration with the laminate dipped into liquid such as water are exemplified. Among them, a method of imparting a liquid containing water to the laminate obtained in the manner described above (particularly, a method of dipping the laminate into the liquid containing water) is preferably employed. Thus, in the particles 11 constituting each of the layers 1, particles not bound by the ultraviolet curable resin are temporarily fixed by the water-soluble resin 12. However, when the liquid containing water is used, the water-soluble resin 12 is dissolved to release the temporary fixation, and thus these unbound particles can be more easily and reliably removed from the three-dimensional structure 100. In addition, it is possible to more reliably prevent the occurrence of defects such as scratches on the three-dimensional structure 100 at the time of removing the unbound particles. Moreover, by employing such a method, the cleaning of the three-dimensional structure 100 can also be performed together with the removing of the unbound particles.

### 2. Three-Dimensional Formation Composition

Next, the three-dimensional formation composition 1′ will be described in detail.

The three-dimensional formation composition 1′ contains a plurality of particles 11.

Hereinafter, each component will be described in detail.

### Particle 11

The particle 11 is a particle whose surface is hydrophobically treated and has at least one reactive group selected from the group consisting of an acrylic group, a methacrylic group, a vinyl group, a styryl group, and an isocyanate group.

As the constituent material of the particle 11, for example, inorganic materials, organic materials, and complexes thereof are exemplified.

As the inorganic material constituting the particle 11, for example, various metals and metal compounds are exemplified. Examples of the metal compounds include: various metal oxides, such as silica, alumina, titanium oxide, zinc oxide, zirconium oxide, tin oxide, magnesium oxide, and potassium titanate; various metal hydroxides, such as magnesium hydroxide, aluminum hydroxide, and calcium hydroxide; various metal nitrides, such as silicon nitride, titanium nitride, and aluminum nitride; various metal carbides, such as silicon carbide and titanium carbide; various metal sulfides, such as zinc sulfide; various metal carbonates, such as calcium carbonate and magnesium carbonate; various metal sulfates, such as calcium sulfate and magnesium sulfate; various metal silicates, such as calcium silicate and magnesium silicate; various metal phosphates, such as calcium phosphate; various metal borates, such as aluminum borate and magnesium borate; and complexes thereof.

As the organic material constituting the particle 11, synthetic resins and natural polymers are exemplified. Specific examples of the organic material include polyethylene resins; polypropylene; polyethylene oxide; polypropylene oxide; polyethylene imine; polystyrene; polyurethane; polyurea; polyester; silicone resins; acrylic silicone resins; a polymer containing (meth)acrylic ester as a constituent monomer, such as polymethyl methacrylate; a crosspolymer (ethylene-acrylic acid copolymer resin or the like) containing (meth)acrylic ester as a constituent monomer, such as methyl methacrylate crosspolymer; polyamide resins, such as nylon 12, nylon 6 and copolymerized nylon; polyimide; carboxymethyl cellulose; gelatin; starch; chitin; and chitosan.

Among these, the particle 11 is preferably an inorganic particle made of an inorganic material, more preferably made of any one selected from the group consisting of silica, calcium carbonate, alumina, and titanium dioxide, and further more preferably made of silica. Thus, it is possible to make the characteristics, such as mechanical strength and light resistance, of the three-dimensional structure particularly excellent. Further, when a particle made of silica is used as the particle 11, since silica is excellent even in fluidity, it is advantageous to form a layer having higher thickness uniformity, and it is possible to make the productivity and dimensional accuracy of the three-dimensional structure 100 particularly excellent. Moreover, when the particle 11 is made of silica, it is possible to more effectively prevent the scattering of light caused by the particle 11 in the surface of the three-dimensional structure to be manufactured.

As silica, commercially available products can be suitably used. Specific examples thereof include Mizukasil P-526, Mizukasil P-801, Mizukasil NP-8, Mizukasil P-802, Mizukasil P-802Y, Mizukasil C-212, Mizukasil P-73, Mizukasil P-78A, Mizukasil P-78F, Mizukasil P-87, Mizukasil P-705, Mizukasil P-707, Mizukasil P-707D, Mizukasil P-709, and Mizukasil C-402, Mizukasil C-484 (all are manufactured by Mizusawa Industrial Chemicals, Ltd.); Tokusil U, Tokusil UR, Tokusil GU, Tokusil AL-1, Tokusil GU-N, Tokusil N, Tokusil NR, Tokusil PR, Solex, Finesil E-50, Finesil T-32, Finesil X-30, Finesil X-37, Finesil X-37B, Finesil X-45, Finesil X-60, Finesil X-70, Finesil RX-70, Finesil A, and Finesil B (all are manufactured by Tokuyama Corporation); SIPERNAT, CARPLEX FPS-101, CARPLEX CS-7, CARPLEX 22S, CARPLEX 80, CARPLEX 80D, CARPLEX XR, and CARPLEX 67 (all are manufactured by DSL. Japan Co., Ltd.); Syloid 63, Syloid 65, Syloid 66, Syloid 77, Syloid 74, Syloid 79, Syloid 404, Syloid 620, Syloid 800, Syloid 150, Syloid 244, and Syloid 266 (all are manufactured by Fuji Silysia Chemical Ltd.); Nipgel AY-200, Nipgel AY-6A2, Nipgel AZ-200, Nipgel AZ-6A0, Nipgel BY-200, Nipgel BY-200, Nipgel CX-200, Nipgel CY-200, Nipsil E-150J, Nipsil E-220A, and Nipsil E-200A (all are manufactured by Tosoh Silica Corporation).

As the hydrophobic treatment applied to the particles 11, any hydrophobic treatment may be used as long as it increases the hydrophobicity of the particles 11, but hydrophobic treatment introducing a hydrocarbon group is preferable. In this case, it is possible to further increase the hydrophobicity of the particles 11. Further, it is possible to easily and reliably further increase the degree of uniformity of the hydrophobic treatment in each particle or each site of a particle surface (including the surface of the inner side of a hole in the case of a porous particle).

As a compound used in hydrophobic treatment, a silane compound (silane coupling agent) containing a silyl group is preferable. Specific examples of the compound used in hydrophobic treatment can include hexamethyldisilazane, dimethyldimethoxysilane, diethyl diethoxysilane, 1-propenyl methyl dichlorosilane, propyl dimethyl chlorosilane, propyl methyl dichlorosilane, propyl trichlorosilane, p-styryltrimethoxysilane, propyl triethoxysilane, propyl trimethoxysilane, styrylethyltrimethoxysilane, tetradecyl trichlorosilane, 3-thiocyanate propyl triethoxysilane, p-tolyl dimethyl chlorosilane, p-tolyl methyl dichlorosilane, p-tolyl trichlorosilane, p-tolyl trimethoxysilane, p-tolyl triethoxysilane, di-n-propyl di-n-propoxysilane, diisopropyl diisopropoxy silane, di-n-butyl di-n-butyloxysilane, di-sec-butyl di-sec-butyloxysilane, di-t-butyl di-t-butyloxysilane, octadecyl trichlorosilane, octadecyl methyldiethoxysilane, octadecyltriethoxysilane, octadecyltrimethoxysilane, octadecyldimethylchlorosilane, octadecyl methyl dichlorosilane, octadecyl methoxy dichlorosilane, 7-octenyl dimethyl chlorosilane, 7-octenyl trichlorosilane, 7-octenyl trimethoxysilane, octyl methyl dichlorosilane, octyl dimethyl chlorosilane, octyl trichlorosilane, 10-undecenyl dimethyl chlorosilane, undecyl trichlorosilane, vinyl dimethyl chlorosilane, methyl octadecyl dimethoxysilane, methyl dodecyl diethoxysilane, methyl octadecyl dimethoxysilane, methyl octadecyl diethoxysilane, n-octyl methyl dimethoxysilane, n-octyl methyldiethoxysilane, triacontyl dimethylchlorosilane, triacontyl trichlorosilane, methyl trimethoxysilane, methyl triethoxysilane, methyl tri-n-propoxysilane, methyl iso-propoxysilane, methyl-n-butyloxysilane, methyltri-sec-butyloxysilane, methyltri-t-butyloxysilane, ethyl trimethoxysilane, ethyl triethoxysilane, ethyltri-n-propoxysilane, ethyl isopropoxysilane, ethyl-n-butyloxysilane, ethyltri-sec-butyloxysilane, ethyltri-t-butyloxysilane, n-propyl trimethoxysilane, isobutyl trimethoxysilane, n-hexyl trimethoxysilane, hexadecyl trimethoxysilane, n-octyl trimethoxysilane, n-dodecyl trimethoxysilane, n-octadecyl trimethoxysilane, n-propyl triethoxysilane, isobutyl triethoxysilane, n-hexyl triethoxysilane, hexadecyl triethoxysilane, n-octyl triethoxysilane, n-dodecyl trimethoxysilane, n-octadecyl triethoxysilane, 2-[2-(trichlorosilyl)ethyl]pyridine, 4-[2-(trichlorosilyl)ethyl]pyridine, diphenyldimethoxysilane, diphenyldiethoxysilane, 1,3-(trichlorosilyl methyl) heptacosane, dibenzyl dimethoxy silane, dibenzyl ethoxy silane, phenyl trimethoxysilane, phenyl methyl dimethoxy silane, phenyl dimethyl methoxysilane, phenyl dimethoxy silane, phenyl diethoxysilane, phenyl methyl diethoxysilane, phenyl dimethyl ethoxysilane, benzyl triethoxysilane, benzyl trimethoxysilane, benzyl methyl dimethoxy silane, benzyl dimethyl methoxysilane, benzyl dimethoxysilane, benzyl diethoxysilane, benzyl methyl diethoxysilane, benzyl dimethyl ethoxysilane, benzyl triethoxysilane, dibenzyl dimethoxysilane, dibenzyl diethoxysilane, 3-acetoxypropyl trimethoxy silane, 3-acryloxypropyltrimethoxysilane, allyl trimethoxysilane, allyl triethoxysilane, 4-aminobutyl triethoxysilane, (aminoethyl aminomethyl) phenethyl trimethoxy silane, N-(2-aminoethyl)-3-aminopropylmethyldimethoxysilane, N-(2-aminoethyl)-3-aminopropyltrimethoxysilane, 6-(aminohexyl aminopropyl)trimethoxysilane, p-aminophenyl trimethoxysilane, p-aminophenyl triethoxysilane, m-aminophenyltrimethoxysilane, m-aminophenyl ethoxysilane, 3-aminopropyltrimethoxysilane, 3-aminopropyltriethoxysilane, ω-amino undecyl trimethoxysilane, amyl triethoxysilane, benzoxasilepin dimethyl ester, 5-(bicycloheptenyl)triethoxysilane, bis(2-hydroxyethyl)-3-aminopropyltriethoxysilane, 8-bromo-octyl trimethoxy silane, bromophenyl trimethoxy silane, 3-bromo-propyl trimethoxysilane, n-butyl trimethoxysilane, 2-chloromethyl-triethoxysilane, chloromethyl methyl diethoxysilane, chloromethyl methyl diisopropoxysilane, p-(chloromethyl) phenyl trimethoxysilane, chloro methyl triethoxysilane, chlorophenyl triethoxysilane, 3-chloropropyl methyl dimethoxysilane, 3-chloro-propyl triethoxysilane, 3-chloropropyl trimethoxysilane, 2-(4-chloro-sulfonyl phenyl) ethyl trimethoxysilane, 2-cyano-ethyl triethoxysilane, 2-cyano-ethyl trimethoxysilane, cyanomethyl phenethyl triethoxysilane, 3-cyanopropyl triethoxysilane, 2-(3-cyclohexenyl)ethyltrimethoxysilane, 2-(3-cyclohexenyl)ethyltriethoxysilane, 3-cyclohexenyl trichlorosilane, 2-(3-cyclohexenyl) ethyl trichlorosilane, 2-(3-cyclohexenyl) ethyl dimethyl chloro silane, 2-(3-cyclohexenyl) ethyl methyl dichloro silane, cyclohexyl dimethyl chlorosilane, cyclohexylethyldimethoxysilane, cyclohexyl methyl dichlorosilane, cyclohexylmethyldimethoxysilane, (cyclohexyl methyl) trichlorosilane, cyclohexyl trichlorosilane, cyclohexyl trimethoxysilane, cyclooctyl trichlorosilane, (4-cyclooctenyl)trichlorosilane, cyclopentyl trichlorosilane, cyclopentyl trimethoxysilane, 1,1-diethoxy-1-silacyclopenta-3-ene, 3-(2,4-dinitrophenyl amino)propyl triethoxysilane, (dimethylchlorosilyl)methyl-7,7-dimethyl norpinane, (cyclohexyl aminomethyl)methyldiethoxysilane, (3-cyclopentadienylpropyl)triethoxysilane, N,N-diethyl-3-aminopropyl)trimethoxysilane, 2-(3,4-epoxycyclohexyl) ethyl trimethoxysilane, 2-(3,4-epoxycyclohexyl) ethyl triethoxysilane, (furfuryl oxymethyl)triethoxysilane, 2-hydroxy-4-(3-triethoxy propoxy)diphenyl ketone, 3-(p-methoxyphenyl) propyl methyl dichlorosilane, 3-(p-methoxyphenyl) propyl trichlorosilane, p-(methylphenethyl) methyl dichlorosilane, p-(methylphenethyl)trichlorosilane, p-(methylphenethyl)dimethylchlorosilane, 3-morpholino-propyl trimethoxy silane, (3-glycidoxypropyl) methyl diethoxysilane, 3-glycidoxypropyl trimethoxysilane, 1,2,3,4,7,7,-hexachloro-6-methyl diethoxysilyl-2-norbornene, 1,2,3,4,7,7,-hexachloro-6-triethoxysilyl-2-norbornene, 3-iodo-propyl trimethoxysilane, 3-isocyanate propyl triethoxysilane, (mercaptomethyl)methyldiethoxysilane, 3-mercaptopropylmethyldimethoxysilane, 3-mercaptopropyl dimethoxysilane, 3-mercaptopropyl triethoxysilane, 3-methacryloxypropyl methyl diethoxysilane, 3-methacryloxypropyl trimethoxysilane, methyl{2-(3-trimethoxysilyl propylamino)ethylamino}-3-propionate, 7-octenyl trimethoxysilane, R—N-α-phenethyl-N′-triethoxysilylpropyl urea, S—N-α-phenethyl-N′-triethoxysilylpropyl urea, phenethyl trimethoxysilane, phenethyl methyl dimethoxysilane, phenethyl dimethyl methoxy silane, phenethyl dimethoxy silane, phenethyl diethoxysilane, phenethyl methyldiethoxysilane, phenethyl dimethyl ethoxysilane, phenethyl triethoxysilane, (3-phenylpropyl)dimethyl chlorosilane, (3-phenylpropyl) methyl dichlorosilane, N-phenylaminopropyl trimethoxysilane, N-(triethoxysilylpropyl) dansylamide, N-(3-triethoxysilylpropyl)-4,5-dihydro-imidazole, 2-(triethoxysilylethyl)-5-(chloro acetoxy) bicycloheptane, (S)—N-triethoxysilylpropyl-O-mentcarbamate, 3-(triethoxysilyl propyl)-p-nitrobenzamide, 3-(triethoxysilyl) propyl succinic anhydride, N-[5-(trimethoxysilyl) 2-aza-1-oxo-pentyl]caprolactam, 2-(trimethoxysilylethyl)pyridine, N-(trimethoxysilylethyl)benzyl-N,N,N-trimethylammonium chloride, phenyl vinyl diethoxysilane, 3-thiocyanate propyl triethoxysilane, (tridecafluoro-1,1,2,2-tetrahydro-octyl)triethoxysilane, N-{3-(triethoxysilyl) propyl}phthalamic acid, (3,3,3-trifluoropropyl) methyl dimethoxy silane, (3,3,3-trifluoropropyl)trimethoxysilane silane, 1-trimethoxysilyl-2-(chloromethyl) phenyl ethane, 2-(trimethoxysilyl) ethyl phenyl sulfonyl azide, p-trimethoxysilylethyl-2-pyridine, trimethoxysilylpropyl diethylene triamine, N-(3-trimethoxysilylpropyl) pyrrole, N-trimethoxysilylpropyl-N,N,N-tributyl ammonium bromide, N-trimethoxysilylpropyl-N,N,N-tri-butyl ammonium chloride, N-trimethoxysilylpropyl-N,N,N-trimethylammonium chloride, vinyl methyl diethoxysilane, vinyl triethoxysilane, vinyl trimethoxysilane, vinyl methyl dimethoxysilane, vinyl dimethyl methoxysilane, vinyl dimethyl ethoxysilane, vinyl methyl dichlorosilane, vinyl phenyl dichlorosilane, vinyl phenyl diethoxysilane, vinyl phenyl dimethyl silane, vinyl phenyl methyl chlorosilane, vinyl triphenoxy silane, vinly tris-t-butoxysilane, adamantylethyl trichlorosilane, allyl phenyl trichlorosilane, (amino ethyl amino methyl) phenethyl trimethoxysilane, 3-aminophenoxy dimethyl vinyl silane, phenyl trichlorosilane, phenyl dimethyl chlorosilane, phenyl methyl dichlorosilane, benzyl trichlorosilane, benzyl dimethyl chlorosilane, benzyl methyl dichlorosilane, phenethyl diisopropylchlorosilane, phenethyl trichlorosilane, phenethyl dimethyl chlorosilane, phenethylmethyldichlorosilane, 5-(bicycloheptenyl)trichlorosilane, 5-(bicycloheptenyl)triethoxysilane, 2-(bicycloheptyl)dimethyl chlorosilane, 2-(bicycloheptyl)trichlorosilane, 1,4-bis(trimethoxysilyl ethyl)benzene, bromophenyl trichlorosilane, 3-phenoxypropyl dimethyl chlorosilane, 3-phenoxypropyl trichlorosilane, t-butyl phenyl chlorosilane, t-butyl phenyl methoxy silane, t-butyl phenyl dichlorosilane, p-(t-butyl) phenethyl dimethyl chlorosilane, p-(t-butyl) phenethyl trichlorosilane, 1,3 (chlorodimethylsilyl methyl) heptacosane, ((chloromethyl) phenyl ethyl)dimethyl chlorosilane, ((chloromethyl) phenyl ethyl) methyl dichlorosilane, ((chloromethyl) phenyl ethyl)trichlorosilane, ((chloromethyl)phenylethyl)trimethoxysilane, chlorophenyl trichlorosilane, 2-cyano-ethyl trichlorosilane, 2-cyanoethylmethyldichlorosilane, 3-cyanopropyl methyldiethoxysilane, 3-cyano-propyl methyl dichlorosilane, 3-cyano-propyl methyl dichlorosilane, 3-cyanopropyl dimethylethoxysilane, 3-cyano-propyl methyl dichlorosilane, 3-cyano-propyl trichlorosilane, and fluorinated alkyl silane. These compounds can be used alone or in a combination of two or more selected therefrom.

Among the above-described compounds, it is preferable that a silane coupling agent which can apply hydrophobic treatment to the surface of the particle 11 and which can introduce at least one reactive group selected from the group consisting of an acrylic group, a methacrylic group, a vinyl group, a styryl group, and an isocyanate group to the surface of the particle 11 is used.

Examples of the silane coupling agent can include vinyl methyldiethoxysilane, vinyl triethoxysilane, vinyl trimethoxysilane, vinyl methyl dimethoxy silane, vinyl dimethyl methoxysilane, vinyl dimethyl ethoxysilane, vinyl methyl dichlorosilane, vinyl phenyl dichlorosilane, vinyl phenyl diethoxysilane, vinyl phenyl dimethyl silane, vinyl phenyl methyl chlorosilane, vinyl triphenoxy silane, vinyl tris-t-butoxysilane, 3-aminophenoxy-dimethyl vinyl silane, phenyl vinyl diethoxy silane, vinyl dimethyl chlorosilane, 3-acryloxypropyltrimethoxysilane, 3-methacryloxypropyl methyl diethoxysilane, 3-methacryloxypropyl methyl dimethoxy silane, 3-methacryloxypropyl trimethoxysilane, 3-isocyanate propyl triethoxysilane, styrylethyl trimethoxysilane, and p-styryl trimethoxysilane. These can be used alone or in a combination of two or more thereof.

When the hydrophobic treatment using the silane compound is performed in a liquid phase, the particles 11 to be subjected to the hydrophobic treatment are dipped into the liquid containing the silane compound, and thus it is possible to suitably advance the desired reaction, so that it is possible to form a chemical adsorption film of the silane compound.

Further, when the hydrophobic treatment using the silane compound is performed in a gas phase, the particles 11 to be subjected to the hydrophobic treatment are exposed to the vapor of the silane compound, and thus it is possible to suitably advance the desired reaction, so that it is possible to form a chemical adsorption film of the silane compound.

The average particle diameter of the particle 11 is not particularly limited, but is preferably 1 μm to 25 μm, and more preferably 1 μm to 15 μm. Thus, it is possible to make the mechanical strength of the three-dimensional structure 100 particularly excellent, it is possible to more effectively prevent the occurrence of involuntary unevenness in the manufactured three-dimensional structure 100, and it is possible to make the dimensional accuracy of the three-dimensional structure 100 particularly excellent. Further, when the fluidity of three-dimensional formation powder or a three-dimensional formation composition containing the three-dimensional formation powder is made particularly excellent, it is possible to make the productivity of the three-dimensional structure 100 particularly excellent. In the invention, the average particle diameter refers to a volume average particle diameter, and can be obtained by measuring a dispersion liquid, which is prepared by adding a sample to methanol and dispersing the sample in methanol for 3 minutes using an ultrasonic disperser, using an aperture of 50 μm measured using a particle size distribution measuring instrument (TA-II, manufactured by Coulter Electronics Inc.) using a coulter counter method.

The Dₘₐₓ of the particle 11 is preferably 3 μm to 40 μm, and more preferably 5 μm to 30 μm. Thus, it is possible to make the mechanical strength of the three-dimensional structure 100 particularly excellent, it is possible to more effectively prevent the occurrence of involuntary unevenness in the manufactured three-dimensional structure 100, and it is possible to make the dimensional accuracy of the three-dimensional structure 100 particularly excellent. Further, when the fluidity of three-dimensional formation powder or a three-dimensional formation composition containing the three-dimensional formation powder is made particularly excellent, it is possible to make the productivity of the three-dimensional structure 100 particularly excellent. Moreover, it is possible to more effectively prevent the scattering of light caused by the particle 11 in the surface of the manufactured three-dimensional structure 100.

When the particles 11 are porous, the porosity of the particles 11 is preferably 50% or more, and more preferably 55% to 90%. In this case, the particles 11 have sufficient space (holes) for infiltrating a binder, and the mechanical strength of the particles 11 themselves can be made excellent, and, as a result, the mechanical strength of the three-dimensional structure 100 in which the binder permeates into the holes can be made particularly excellent. In the invention, the porosity of particles refers to a ratio (volume ratio) of holes existing in the particles with respect to the apparent volume of the particles, and is a value represented by {(ρ₀−ρ)/ρ₀}×100 (here, the density of the particles is ρ [g/cm³], and the true density of the constituent material of the particles is ρ₀ [g/cm³]).

When the particles 11 are porous, the average hole diameter (pore diameter) of the particles 11 is preferably 10 nm or more, and more preferably 50 nm to 300 nm. In this case, the mechanical strength of the three-dimensional structure 100 to be finally obtained can be made particularly excellent. Further, when a colored ink containing a pigment is used in manufacturing the three-dimensional structure 100, the pigment can be suitably retained in the pores of the particles 11. Therefore, it is possible to prevent the involuntary diffusion of the pigment, and thus it is possible to more reliably form a high-definition image.

In addition, the refractive index of the particles 11 is preferably 1.40 to 1.55, and more preferably 1.42 to 1.53. In this case, it is possible to more effectively prevent the scattering of light caused by the particles 11 in the surface of the three-dimensional structure 100 to be manufactured.

The particle 11 may have any shape, but, preferably, has a spherical shape. Thus, when the fluidity of three-dimensional formation powder or a three-dimensional formation composition containing the three-dimensional formation powder is made particularly excellent, it is possible to make the productivity of the three-dimensional structure 100 particularly excellent. Further, it is possible to more effectively prevent the occurrence of involuntary unevenness in the manufactured three-dimensional structure 100, and it is possible to make the dimensional accuracy of the three-dimensional structure 100 particularly excellent. Moreover, it is possible to more effectively prevent the scattering of light caused by the particle 11 in the surface of the manufactured three-dimensional structure 100.

The content ratio of three-dimensional formation powder in the three-dimensional formation composition 1′ is preferably 10 mass % to 90 mass %, and more preferably 15 mass % to 58 mass %. Thus, the fluidity of the three-dimensional formation composition 1′ can be made sufficiently excellent, and the mechanical strength of the three-dimensional structure 100 to be finally obtained can be made particularly excellent.

### Water-Soluble Resin

The three-dimensional formation composition 1′ may contain a plurality of particles 11 and a water-soluble resin 12. By allowing the three-dimensional formation composition 1′ to contain the water-soluble resin 12, the particles 11 are bound (temporarily fixed) together (refer to FIG. 3) to effectively prevent the involuntary scattering of the particles 11. Thus, it is possible to improve the safety of workers or the dimensional accuracy of the manufactured three-dimensional structure 100.

In the invention, the water-soluble resin 12 may be a resin in which at least a part thereof is soluble in water. For example, the solubility (dissolvable mass in 100 g of water) of the water-soluble resin 12 in water at 25° C. is preferably 5 [g/100 g water] or more, and more preferably 10 [g/100 g water] or more.

Examples of the water-soluble resin 12 include synthetic polymers, such as polyvinyl alcohol (PVA), polyvinyl pyrrolidone (PVP), polycaprolactam diol, sodium polyacrylate, polyacrylamide, modified polyamide, polyethylene imine, polyethylene oxide, and a random copolymer of ethylene oxide and propylene oxide; natural polymers, such as cornstarch, mannan, pectin, agar, alginic acid, dextran, glue, and gelatin; and semi-synthetic polymers, such as carboxymethyl cellulose, hydroxyethyl cellulose, oxidized starch, and modified starch. They can be used alone or in a combination of two or more selected therefrom.

Specific examples of the water-soluble product include methyl cellulose (Metolose SM-15, manufactured by Shin-Etsu Chemical Co., Ltd.), hydroxyethyl cellulose (AL-15, manufactured by Fuji Chemical Industries Ltd.), hydroxypropyl cellulose (HPC-M, manufactured by Nippon Soda Co., Ltd.,), carboxymethyl cellulose (CMC-30, manufactured by Nichirin Chemical Co.), starch sodium phosphate (I) (Hosuta 5100, manufactured by Matsutani Chemical Industry Co., Ltd.), polyvinyl pyrrolidone (PVP K-90, manufactured by Tokyo Chemical Industry Co., Ltd.), a copolymer of methyl vinyl ether and anhydrous maleic acid (AN-139, manufactured by GAF Gauntlet Corporation), polyacrylamide (manufactured by Wako Pure Chemical Industries, Ltd.), modified polyamide (modified nylon) (AQ nylon, manufactured by Toray Industries, Inc.), polyethylene oxide (PEO-1, manufactured by Steel Chemical Co., Ltd.; Alcox, manufactured by Meisei Chemical Works, Ltd.), a random copolymer of ethylene oxide and propylene oxide (Alcox EP, manufactured by Meisei Chemical Works, Ltd.), sodium polyacrylate (manufactured by Wako Pure Chemical Industries, Ltd.), and carboxy vinyl polymer/cross-linked acrylic water-soluble resin (AQUPEC, manufactured by Sumitomo Seika Chemicals Co., Ltd.).

Among these, when the water-soluble resin 12 used is polyvinyl alcohol, the mechanical strength of the three-dimensional structure 100 can be made particularly excellent. The characteristics (for example, solubility in water, water resistance, and the like) of the water-soluble resin 12 and the characteristics (for example, viscosity, fixing force of particles 11, wettability, and the like) of the three-dimensional formation composition 1′ can be more suitably controlled by adjusting the saponification degree and polymerization degree. Therefore, it is possible to appropriately cope with the manufacture of various three-dimensional structures 100. In addition, among various water-soluble resins, polyvinyl alcohol is inexpensive, and the supply thereof is stable. Therefore, it is possible to stably manufacture the three-dimensional structure 100 while suppressing the production cost thereof.

When the water-soluble resin 12 contains polyvinyl alcohol, the saponification degree of the polyvinyl alcohol is preferably 85 to 90. In this case, it is possible to suppress the decrease in solubility of polyvinyl alcohol in water. Therefore, when the three-dimensional formation composition 1′ contains water, it is possible to more effectively suppress the deterioration in adhesiveness between the adjacent layers 1.

When the water-soluble resin 12 contains polyvinyl alcohol, the polymerization degree of the polyvinyl alcohol is preferably 300 to 1000. In this case, when the three-dimensional formation composition 1′ contains water, it is possible to make the mechanical strength of each of the layers 1 or the adhesiveness between the adjacent layers 1 particularly excellent.

Further, when the water-soluble resin 12 is polyvinyl pyrrolidone (PVP), the following effects can be obtained. That is, since polyvinyl pyrrolidone has excellent adhesiveness to various materials, such as glass, metals, and plastics, the strength and shape stability of the portion of the layer 1 in which ink is not applied can be made particularly excellent, and thus the dimensional accuracy of the three-dimensional structure 100 to be finally obtained can also be made particularly excellent. Further, since polyvinyl pyrrolidone exhibits high solubility in various organic solvents, when the three-dimensional formation composition 1′ contains an organic solvent, the fluidity of the three-dimensional formation composition 1′ can be made particularly excellent, and it is possible to suitably form the layer 1 whose unintentional variation in thickness is prevented more effectively, and thus the dimensional accuracy of the three-dimensional structure 100 to be finally obtained can also be made particularly excellent. Further, since polyvinyl pyrrolidone exhibits high solubility in water, in the unbound particle removal process (after the completion of formation), particles not bound by the curable resin 21 in the particles 11 constituting each layer 1 can be removed easily and reliably. Further, since polyvinyl pyrrolidone has suitable affinity to three-dimensional formation powder, the permeation into the above-described holes 111 does not sufficiently occur, whereas the wettability to the surface of the particles 11 is comparatively high. Therefore, it is possible to more effectively exhibit the above-described temporary fixation function. Further, since polyvinyl pyrrolidone has excellent affinity to various colorants, when the curable ink 2 containing a colorant is used in the ink application process, it is possible to prevent the colorant from being unintentionally spread. Further, since polyvinyl pyrrolidone has an antistatic function, when powder, which is not paste, is used as the three-dimensional formation composition 1′ in the layer forming process, it is possible to effectively prevent the scattering of the powder. Further, in the case where a composition in the form of paste is used as the three-dimensional formation composition 1′ in the layer forming process, when the paste-like three-dimensional formation composition 1′ contains polyvinyl pyrrolidone, it is possible to effectively prevent bubbles from being caught in the three-dimensional formation composition 1′, and thus it is possible to more effectively prevent the defects due to the entrainment of bubbles from occurring in the layer forming process.

When the water-soluble resin 12 contains polyvinyl pyrrolidone, the weight average molecular weight of the polyvinyl pyrrolidone is preferably 10000 to 1700000, and more preferably 30000 to 1500000. In this case, the above-described functions can be more effectively exhibited.

In the three-dimensional formation composition 1′, preferably, the water-soluble resin 12, at least in the layer forming process, is present in a liquid state (for example, a dissolved state, a molten state, or the like). Thus, it is possible to easily and reliably make the thickness uniformity of the layer 1 formed using the three-dimensional formation composition 1′ higher.

The content ratio of the water-soluble resin 12 in the three-dimensional formation composition 1′ is preferably 15 vol % or less, and more preferably 2 vol % to 5 vol %, based on the bulk volume of the particle 11. Thus, the aforementioned function of the water-soluble resin 12 can be sufficiently exhibited, a space through which the curable ink 2 invades can be further widely secured, and the mechanical strength of the three-dimensional structure 100 can be made particularly excellent.

### Solvent

The three-dimensional formation composition 1′ may contain a solvent in addition to the aforementioned water-soluble resin 12 and particle 11. Thus, the fluidity of the three-dimensional formation composition 1′ becomes particularly excellent, and thus, the productivity of the three-dimensional structure 100 can be particularly improved.

As the solvent, a solvent dissolving the water-soluble resin 12 is preferable. Thus, the fluidity of the three-dimensional formation composition 1′ can be improved, and thus it is possible to more effectively prevent the unintentional variation in the thickness of the layer 1 which is formed using the three-dimensional formation composition 1′. In addition, when the layer 1 is formed in a state in which the solvent was removed, it is possible to adhere the water-soluble resin 12 to the particle 11 with higher uniformity over the entire layer 1, and thus it is possible to more effectively prevent unintentional compositional unevenness from occurring. Therefore, it is possible to more effectively prevent the occurrence of unintentional variation in mechanical strength at each site of the finally obtained three-dimensional structure 100, and it is possible to further increase the reliability of the three-dimensional structure 100.

Examples of the solvent constituting the three-dimensional formation composition 1′ include water; alcoholic solvents, such as methanol, ethanol, and isopropanol; ketone-based solvents, such as methyl ethyl ketone and acetone; glycol ether-based solvents, such as ethylene glycol monoethyl ether and ethylene glycol monobutyl ether; glycol ether acetate-based solvents, such as propylene glycol 1-monomethyl ether 2-acetate and propylene glycol 1-monomethyl ether 2-acetate; polyethylene glycol; and polypropylene glycol. These can be used alone or in a combination of two or more selected therefrom.

Preferably, the three-dimensional formation composition 1′ contains water. Therefore, the water-soluble resin 12 can be more reliably dissolved, and thus the fluidity of the three-dimensional formation composition 1′ or the composition uniformity of the layer 1 formed using the three-dimensional formation composition 1′ can be made particularly excellent. Further, water is easily removed after the formation of the layer 1, and does not negatively influence the three-dimensional formation composition 1′ even when it remains in the three-dimensional structure 100. Moreover, water is advantageous in terms of safety for both humans and the environment.

When the three-dimensional formation composition 1′ contains a solvent, the content ratio of the solvent in the three-dimensional formation composition 1′ is preferably 5 mass % to 75 mass %, and more preferably 35 mass % to 70 mass %. Thus, the aforementioned effects, due to the solvent being contained therein, can be more remarkably exhibited, and, in the process of manufacturing the three-dimensional structure 100, the solvent can be easily removed in a short period of time, and thus it is advantageous in terms of improvement in productivity of the three-dimensional structure 100.

In particular, when the three-dimensional formation composition 1′ contains water as the solvent, the content ratio of water in the three-dimensional formation composition 1′ is preferably 20 mass % to 73 mass %, and more preferably 50 mass % to 70 mass %. Thus, the aforementioned effects are more remarkably exhibited.

### Other Components

The three-dimensional formation composition 1′ may contain components other than the aforementioned components. Examples of these components include a polymerization initiator; a polymerization accelerator; a penetration enhancer; a wetting agent (humectant); a fixing agent; a fungicide; a preservative; an antioxidant; an ultraviolet absorber; a chelating agent; and a pH adjuster.

### 3. Curable Ink

Next, the ink used in manufacturing the three-dimensional structure of the invention will be described in detail.

### Curable Resin

The curable ink 2 contains monofunctional and/or difunctional (meth)acrylate as a curable resin 21. In this case, the above-described reactive group on the surface of the particles 11 can react with the curable resin 21, and thus it is possible to chemically bond the curable ink 2 and the particles 11. As a result, it is possible to increase the mechanical strength of the three-dimensional structure 100 to be obtained.

Specific examples of the monofunctional (meth)acrylate include tolyloxyethyl(meth)acrylate, phenyloxyethyl(meth)acrylate, cyclohexyl(meth)acrylate, ethyl(meth)acrylate, methyl(meth)acrylate, isobornyl(meth)acrylate, and tetrahydrofurfuryl(meth)acrylate.

Specific examples of the difunctional (meth)acrylate include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, and dipentaerythritol di(meth)acrylate.

The above (meth)acrylate is a compound in which a curing reaction proceeds by ultraviolet irradiation or heating. Further, the (meth)acrylate is a compound in which a reaction with the reactive group of the surface of the particle 11 proceeds by ultraviolet irradiation or heating.

The curable ink 2 may contain a curable resin other than the (meth)acrylate.

The content ratio of the (meth)acrylate in the curable ink 2 is preferably 80 mass % or more, and preferably mass % or more. Thus, it is possible to make the mechanical strength of the finally obtained three-dimensional structure 100 particularly excellent.

### Other Components

The curable ink 2 may contain other components in addition to the above-mentioned components. Examples of these components include various colorants such as pigment and dyes; dispersants; surfactants; polymerization initiators; polymerization accelerators; solvents; penetration enhancers; wetting agents (humectants); fixing agents; antifungal agents; preservatives; antioxidants; UV absorbers; chelating agents; pH adjusting agents; thickeners; fillers; aggregation inhibitors; and defoamers.

Particularly, when the curable ink 2 contains the colorant, it is possible to obtain a three-dimensional structure 100 colored by a color corresponding to the color of the colorant.

Particularly, when the curable ink 2 contains pigment as the colorant, it is possible to make the light resistance of the curable ink 2 or the three-dimensional structure 100 good. As the pigment, both inorganic pigments and organic pigments can be used.

Examples of inorganic pigments include carbon blacks (C. I. Pigment Black 7) such as furnace black, lamp black, acetylene black, and channel black; iron oxide; and titanium oxide. These can be used alone or in a combination of two or more selected therefrom.

Among these inorganic pigments, in order to exhibit the preferred white color, titanium oxide is preferable to be used.

Examples of organic pigments include azo pigments such as insoluble azo pigments, condensed azo pigments, azo lakes, and chelate azo pigments; polycyclic pigments such as phthalocyanine pigments, perylene and perinone pigments, anthraquinone pigments, quinacridone pigments, dioxane pigments, thioindigo pigments, isoindolinone pigments, quinophthalone pigments; dye chelates (for example, basic dye chelates, acidic dye chelates, and the like); staining lakes (basic dye lakes, acidic dye lakes); nitro pigments; nitroso pigments; aniline blacks; and daylight fluorescent pigments. They can be used alone or in a combination of two or more selected therefrom.

More specifically, examples of carbon black used as black pigment include No. 2300, No. 900, MCF88, No. 33, No. 40, No. 45, No. 52, MA7, MA8, MA100, and No. 2200B (all are manufactured by Mitsubishi Chemical Corporation); Raven 5750, Raven 5250, Raven 5000, Raven 3500, Raven 1255, and Raven 700 (all are manufactured by Carbon Columbia Co., Ltd.); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all are manufactured by CABOT JAPAN K.K.); and Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all are manufactured by Degussa Co., Ltd.).

Examples of white pigment include C. I. Pigment White 6, 18, and 21.

Examples of yellow pigment include C. I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of red-violet (magenta) pigment include C. I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57: 1, 88, 112, 114, 122, 123, 144, 146, 149, 150, 166, 168, 170, 171, 175, 176, 177, 178, 179, 184, 185, 187, 202, 209, 219, 224, and 245; and C. I. Pigment Violet 19, 23, 32, 33, 36, 38, 43, and 50.

Examples of indigo-violet (cyan) pigment include C. I. Pigment Blue 1, 2, 3, 15, 15:1, 15:2, 15:3, 15:34, 15:4, 16, 18, 22, 25, 60, 65, and 66; and C. I. Bat Blue 4 and 60.

Examples of pigments other than the above pigments include C. I. Pigment Green 7 and 10; C. I. Pigment Brown 3, 5, 25, and 26; C. I. Pigment Orange 1, 2, 5, 7, 13, 14, 15, 16, 24, 34, 36, 38, 40, 43, and 63.

When the curable ink 2 contains a pigment, the average particle diameter of the pigment is preferably 300 nm or less, and more preferably 50 nm to 250 nm. Thus, the discharge stability of the curable ink 2 and the dispersion stability of the pigment in the curable ink 2 can be particularly excellent, and images with better image quality can be formed.

In the case where the curable ink 2 contains the pigment, when the average particle diameter of the particle 11 is expressed by d1 [nm] and the average particle diameter of the pigment is expressed by d2 [nm], preferably, the relationship of d1/d2>1 is satisfied, and, more preferably, the relationship of 1.1≦d1/d2≦6 is satisfied. When this relationship is satisfied, the pigment can be suitably retained in the holes of the particle 11. Therefore, the involuntary scattering of the pigment can be prevented, and thus it is possible to reliably form an image with high dimensional accuracy.

Examples of dyes include acid dyes, direct dyes, reactive dyes, and basic dyes. They can be used alone or in a combination of two or more thereof.

Specific examples of dyes include C. I. Acid Yellow 17, 23, 42, 44, 79, and 142; C. I. Acid Red 52, 80, 82, 249, 254, and 289; C. I. Acid Blue 9, 45, and 249; C. I. Acid Black 1, 2, 24, and 94; C. I. Food Black 1, and 2; C. I. Direct Yellow 1, 12, 24, 33, 50, 55, 58, 86, 132, 142, 144, and 173; C. I. Direct Red 1, 4, 9, 80, 81, 225, and 227; C. I. Direct Blue 1, 2, 15, 71, 86, 87, 98, 165, 199, and 202; C. I. Direct black 19, 38, 51, 71, 154, 168, 171, and 195; C. I. Reactive Red 14, 32, 55, 79, and 249; and C. I. Reactive Black 3, 4, and 35.

When the curable ink 2 contains a colorant, the content ratio of the colorant in the curable ink 2 is preferably 1 mass % to 20 mass %. Thus, particularly excellent hiding properties and color reproducibility are obtained.

Particularly, when the curable ink 2 contains titanium oxide as the colorant, the content ratio of titanium oxide in the curable ink 2 is preferably 12 mass % to 18 mass %, and more preferably 14 mass % to 16 mass %. Thus, particularly excellent hiding properties are obtained.

When the curable ink 2 contains a dispersant in addition to a pigment, the dispersibility of the pigment can be further improved. As a result, it is possible to more effectively suppress the partial reduction in mechanical strength due to the bias of the pigment.

The dispersant is not particularly limited, but examples thereof include dispersants, such as polymer dispersant, generally used in preparing a pigment dispersion liquid. Specific examples of the polymer dispersants include polymer dispersants containing one or more of polyoxyalkylene polyalkylene polyamine, vinyl polymers and copolymers, acrylic polymers and copolymers, polyesters, polyamides, polyimides, polyurethanes, amino-based polymers, silicon-containing polymers, sulfur-containing polymers, fluorinated polymers, and epoxy resins, as main components. Examples of commercially available products of polymer dispersants include AJISPER series of Ajinomoto Fine-techno Co., Inc.; Solspers series (Solsperse 36000 and the like) commercially available from Noveon Corporation; DISPERBYK series of BYK Japan K.K.; and DISPERBYK series of Kusumoto Chemicals, Ltd.

When the curable ink 2 contains a surfactant, the abrasion resistance of the three-dimensional structure 100 may be improved. The surfactant is not particularly limited, but examples thereof include silicone-based surfactants such as polyester-modified silicone, and polyether-modified silicone. Among these, polyether-modified polydimethylsiloxane or polyester-modified polydimethylsiloxane is preferably used. Specific examples of the surfactant include BYK-347, BYK-348, BYK-UV3500, 3510, 3530, and 3570 (all are trade names of BYK Japan K.K.).

The curable ink 2 may contain a solvent. Thus, the viscosity of the curable ink 2 can be suitably adjusted, and the discharge stability of the curable ink 2 by an ink jet method can be particularly excellent even when it contains a component having high viscosity.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetic acid esters, such as ethyl acetate, n-propyl acetate, iso-propyl acetate, n-butyl acetate, and iso-butyl acetate; aromatic hydrocarbons such as benzene, toluene, and xylene; ketones, such as methyl ethyl ketone, acetone, methyl isobutyl ketone, ethyl-n-butyl ketone, diisopropyl ketone, and acetylacetone; and alcohols, such as ethanol, propanol, and butanol. These can be used alone or in a combination of two or more thereof.

The viscosity of the curable ink 2 is preferably 10 mPa·s to 25 mPa·s, and more preferably 15 mPa·s to 20 mPa·s. Thus, the discharge stability of ink by an ink jet method can be particularly excellent. In the present specification, viscosity refers to a value measured at 25° C. using an E-type viscometer (VISCONIC ELD, manufactured by Tokyo Keiki Inc.).

Meanwhile, in the manufacture of the three-dimensional structure 100, several kinds of curable ink 2 may be used.

For example, curable ink 2 (color ink) containing a colorant and curable ink 2 (clear ink) containing no colorant may be used. Thus, for example, for the appearance of the three-dimensional structure 100, the curable ink 2 containing a colorant may be used as a curable ink 2 applied to the region influencing color tone, and, for the appearance of the three-dimensional structure 100, the curable ink 2 containing no colorant may be used as a curable ink 2 applied to the region not influencing color tone. Further, in the three-dimensional structure 100 to be finally obtained, several kinds of curable inks 2 may be used in combination with each other such that the region (coating layer) formed using the curable ink 2 containing no colorant is provided on the outer surface of the region formed using the curable ink 2 containing a colorant.

For example, several kinds of curable inks 2 containing colorants having different compositions from each other may be used. Thus, a wider color reproducing area that can be expressed can be realized by the combination of these curable inks 2.

When several kinds of curable inks 2 are used, it is preferable that at least indigo-violet (cyan) curable ink 2, red-violet (magenta) curable ink 2, and yellow curable ink 2 are used. Thus, a wider color reproducing area that can be expressed can be realized by the combination of these curable inks 2.

Further, for example, the following effects are obtained by the combination of white curable ink 2 and the other colored curable ink 2. That is, the three-dimensional structure 100 to be finally obtained can have a first area on which white curable ink 2 is applied, and a second area which is overlapped with the first area and provided on the outside of the first area and on which curable ink 2 having a color other than white is applied. Thus, the first area on which white curable ink 2 is applied can exhibit hiding properties, and the color saturation of the three-dimensional structure 100 can be enhanced.

### 4. Three-Dimensional Formation Material

The three-dimensional formation material of the invention includes the above-described three-dimensional formation composition and curable ink.

In this case, it is possible to more efficiently manufacture a three-dimensional structure having excellent mechanical strength.

### 5. Three-Dimensional Structure Manufacturing Apparatus

Next, the three-dimensional structure manufacturing apparatus 1000 according to the present embodiment will be described.

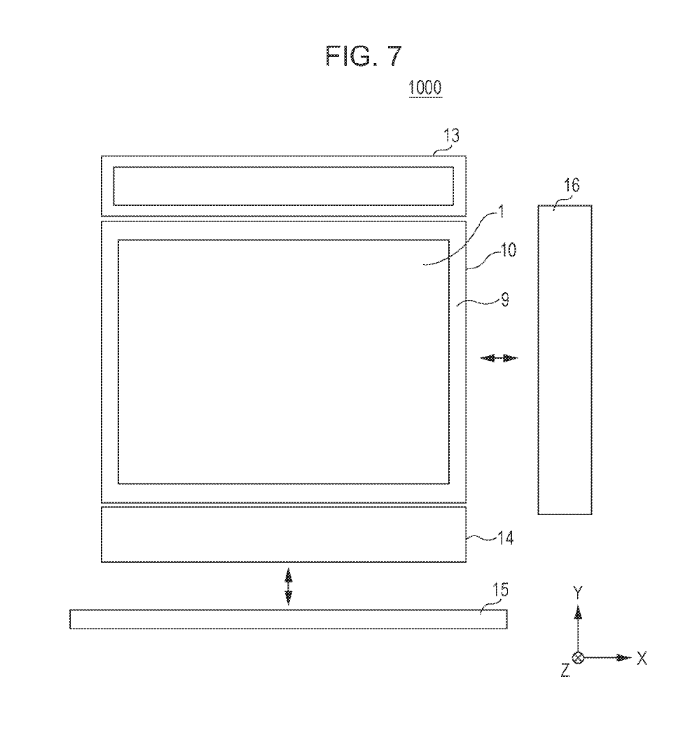

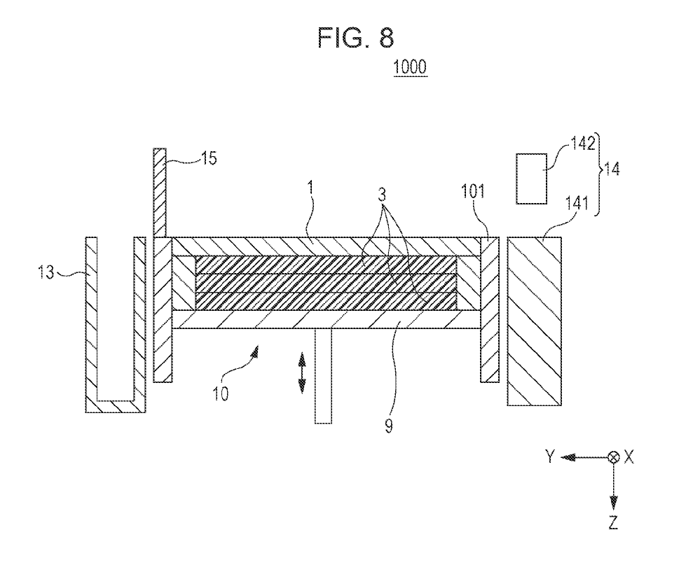

FIG. 7 is a plan view showing a preferred embodiment of the three-dimensional structure manufacturing apparatus of the invention, and FIG. 8 is a cross-sectional view of the three-dimensional structure manufacturing apparatus, which is seen from the right direction of FIG. 7.

The three-dimensional structure manufacturing apparatus 1000 is an apparatus for manufacturing a three-dimensional structure by laminating the cured portions (unit layers) 3 formed using the three-dimensional formation composition containing three-dimensional formation powder.

In the three-dimensional structure manufacturing apparatus 1000, a three-dimensional structure is manufactured by laminating the layers formed using the three-dimensional formation composition containing three-dimensional formation powder.

As shown in FIGS. 7 and 8, the three-dimensional structure manufacturing apparatus 1000 includes: a formation unit 10 on which a three-dimensional structure is formed; a supply unit 14 that supplies a three-dimensional formation composition; a squeegee (layer formation unit) 15 that forms a three-dimensional formation composition layer 1 on the formation unit 10 using the supplied three-dimensional formation composition; a recovery unit 13 that recovers the excessive three-dimensional formation composition at the time of forming the layer 1; and an ink discharge unit 16 that discharges curable ink onto the layer 1.

The formation unit 10, as shown in FIGS. 7 and 8, includes a frame 101, and a formation stage 9 provided in the frame 101.

The frame 101 is formed of a frame-shaped member.

The formation stage 9 has a rectangular shape in the XY plane.

Further, the formation stage 9 is configured to be driven (lifted) in the Z-axis direction by a driving unit (not shown).

The layer 1 is formed in a region formed by the inner wall surface of the frame 101 and the formation stage 9.

Further, the formation unit 10 is configured to be driven in the X-axis direction by a driving unit (not shown).

When the formation unit 10 moves in the X-axis direction, that is, moves to the drawing region of the ink discharge unit 16 to be described later, curable ink is discharged onto the layer 1 by the ink discharge unit 16.

The supply unit 14 functions to supply the three-dimensional formation composition into the three-dimensional structure manufacturing apparatus 1000.

The supply unit 14 includes a supply region 141 in which the three-dimensional formation composition is supplied, and a supply unit 142 that supplies the three-dimensional formation composition into the supply region 141.

The supply region 141 has a long rectangular shape in the X-axis direction, and is provided in contact with one side of the frame 101. Further, the supply region 141 is provided to be flush with the upper surface of the frame 101.

The three-dimensional formation composition supplied in the supply region 141 is transported to the formation stage 9 by the squeegee 15 to be described later, and is thus formed into the layer 1.

The squeegee (layer formation unit) 15 has a long plate shape in the X-axis direction. Further, the squeegee 15 is configured to be driven in the Y-axis direction by a driving unit (not shown). Moreover, the squeegee 15 is configured such that its short-axis direction end is in contact with the upper surface of the frame 101 and the supply region 141.

This squeegee 15 transports the three-dimensional formation composition supplied in the supply region 141 to the formation stage 9 while moving in the Y-axis direction, so as to form the layer 1 on the formation stage 9.

In the present embodiment, it is configured such that the moving direction of the squeegee 15 and the moving direction of the formation unit 10 intersect with each other (perpendicular to each other). By employing this configuration, at the time of discharging curable ink using the ink discharge unit 16, the formation of the next layer 1 can be prepared, and thus it is possible to improve the production efficiency of the three dimensional structure.

The recovery unit 13 is a box-shaped member having an open upper surface, and is provided separately from the formation unit 10. This recovery unit 13 has a function of recovering the excessive three-dimensional formation composition in the formation of the layer 1.

The recovery unit 13 is in contact with the frame 101, and is provided to face the supply unit 14 through the frame 101.

The excessive three-dimensional formation composition transported by the squeegee 15 is recovered by this recovery unit 13, and this recovered three-dimensional formation composition is reused.

The ink discharge unit 16 has a function of discharging the curable ink onto the formed layer 1.

Specifically, when the formation unit 10 in which the layer 1 is formed on the formation stage 9 is moved in the X-axis direction and is approaching the bottom of the drawing region of the ink discharge unit 16, the curable ink is discharged from the ink discharge unit 16 onto the layer 1.

The ink discharge unit 16 is mounted with a droplet ejection head that ejects droplets of the curable ink by an ink jet method. Further, the ink discharge unit 16 is provided with a curable ink supply unit (not shown). In the present embodiment, a droplet ejection head using a so-called piezoelectric driving method is employed.

In the three-dimensional structure manufacturing apparatus 1000, a curing unit (not shown) for curing the curable ink is provided in the vicinity of the ink discharge unit 16.

In the above description, the case where the squeegee 15 was used as the layer formation unit has been described. However, the layer formation unit is not limited to the squeegee 15, and, for example, a roller may be used.

The recovery unit 13 may be provided with a removal unit that removes the three-dimensional formation composition adhered to the squeegee 15. As the removal unit, ultrasonic waves, a wiper, or static electricity can be used.

### 6. Three-Dimensional Structure

The three-dimensional structure of the invention can be manufactured using the above-mentioned method. Thus, it is possible to provide a manufactured three-dimensional structure with excellent mechanical strength.

Applications of the three-dimensional structure of the invention are not particularly limited, but examples thereof appreciated and exhibited objects such as dolls and figures; and medical instruments such as implants; and the like.

In addition, the three-dimensional structure of the invention may be applied to prototypes, mass-produced products, made-to-order goods, and the like.

Although preferred embodiments of the invention have been described, the invention is not limited thereto.

More specifically, for example, it has been described in the aforementioned embodiment that, in addition to the layer forming process and the ink discharge process, the curing process is also repeated in conjunction with the layer forming process and the ink discharge process. However, the curing process may not be repeated. For example, the curing process may be carried out collectively after forming a laminate having a plurality of layers that are not cured.

In the method of manufacturing a three-dimensional structure according to the invention, if necessary, a pre-treatment process, an intermediate treatment process, or a post-treatment process may be carried out.

As an example of the pre-treatment process, a process of cleaning a support (stage) is exemplified.

As the intermediate treatment process, for example, when the three-dimensional formation composition contains a solvent component (dispersion medium) such as water, a process of removing the solvent component may be carried out between the layer forming process and the ink discharge process. Thus, the layer forming process can be more smoothly performed, and the unintentional variation in the thickness of the formed layer can be more effectively prevented. As a result, it is possible to manufacture a three-dimensional structure having higher dimensional accuracy and higher productivity.

Examples of the post-treatment process include a cleaning process, a shape adjusting process of performing deburring or the like, a coloring process, a process of forming a covering layer, and an ultraviolet curable resin curing completion process of performing light irradiation treatment or heat treatment for reliably curing an uncured ultraviolet curable resin.

Further, it has been described in the aforementioned embodiment that ink is applied to all of the layers. However, a layer on which ink is not applied may exist. For example, ink may not be applied to the layer formed directly on a support (stage), thus allowing this layer to function as a sacrificial layer.

Moreover, in the aforementioned embodiment, the case of performing the ink discharge process using an ink jet method has been mainly described. However, the ink discharge process may be performed using other methods (for example, other printing methods).

### EXAMPLES

Hereinafter, the invention will be described in more detail with reference to the following specific Examples, but the invention is not limited to these Examples. In the following description, particularly, it is assumed that treatment showing no temperature condition is performed at room temperature (25° C.). Further, in the case where a temperature condition is not shown even in various measurement conditions, it is assumed that the measured values are values measured at room temperature (25° C.)

### [1] Manufacture of Three-Dimensional Structure

### Example 1

### 1. Preparation of Three-Dimensional Formation Composition

First, powder composed of silica particles (trade name: X-37B, manufactured by Tokuyama Corporation, average particle diameter: 5 μm) was prepared.

This silica powder was dispersed in isopropyl alcohol to obtain a dispersion liquid.

Meanwhile, vinyl triethoxysilane was dissolved in isopropyl alcohol to obtain a solution.

Next, the dispersion liquid and the solution were mixed to perform hydrophobic treatment and introduction of a vinyl group to a particle surface.

Thereafter, isopropyl alcohol and unreacted vinyl triethoxysilane were removed to obtain treated powder.

Next, 100 parts by mass of the treated powder, 325 parts by mass of water, and 50 parts by mass of polyvinyl pyrrolidone (weight average molecular weight: 50,000) were mixed to obtain a three-dimensional formation composition.

### 2. Manufacture of Three-Dimensional Structure

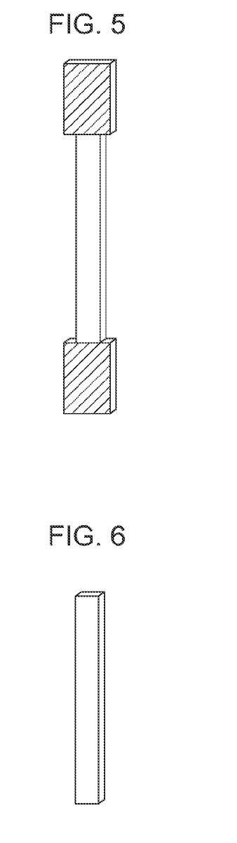

The three-dimensional structure A having a shape shown in FIG. 5, that is, having a shape with a 4 mm (thickness)×150 mm (length), each of the regions provided at both ends indicated by hatching (upper and lower ends in FIG. 5) has a width of 20 mm and a length of 35 mm, and the region that is sandwiched between these regions has a width of 10 mm and a length of 80 mm was manufactured using the obtained three-dimensional formation composition as follows. Further, the three-dimensional structure B having a shape shown in FIG. 6, that is, having a cubic shape of 4 mm (thickness)×10 mm (width)×80 mm (length) was also manufactured using the obtained three-dimensional formation composition as follows.

First, a three-dimension forming apparatus was prepared, and a layer (thickness: 100 μm) was formed on the surface of a support (stage) using the three-dimensional formation composition by a squeegee method (layer forming process).

Next, the formed layer was left at room temperature for 1 minute, thereby removing water contained in the three-dimensional formation composition.

Next, curable ink was applied to the layer made of the three-dimensional formation composition in a predetermined pattern by an ink jet method (ink discharge process). As the curable ink, curable ink having the following composition and a viscosity of 22 mPa·s at 25° C. was used.

### Ultraviolet Curable Resin

phenoxy tolyloxyethyl acrylate: 60 mass %

ethylene glycol diacrylate: 31.75 mass %

### Polymerization Initiator

bis(2,4,6-trimethylbenzoyl)-phenylphosphine oxide: 5 mass %

2,4,6-trimethylbenzoyl-diphenylphosphine oxide: 4 mass % Fluorescent whitening agent (sensitizer)

1,4-bis-(benzoxazoyl-2-yl) naphthalene: 0.25 mass %

Next, the layer was irradiated with ultraviolet rays to cure the ultraviolet curable resin contained in the three-dimensional formation composition (curing process).

Thereafter, a series of processes of the layer forming process to the curing process were repeated such that a plurality of layers were laminated while changing the pattern of the applied ink depending on the shape of the three-dimensional structure to be manufactured.

Thereafter, the laminate obtained in this way was dipped into water, and ultrasonic vibration was applied thereto to remove the particles not bound by the ultraviolet curable resin (unbound particles) from the particles constituting each of the layers, thereby obtaining the three-dimensional structure A and the three-dimensional structure B two by two, respectively.

Thereafter, a drying process was carried out at 60° C. for 20 minutes.

### Examples 2 to 8

Three-dimensional structures were respectively manufactured in the same manner as in Example 1, except that the configuration of each of the three-dimensional formation compositions was changed as shown in Table 1 by changing the kinds of raw materials used in preparing the three-dimensional formation composition and the combination ratio of each of the components, and that the curable resin of the curable ink was changed as shown in Table 1.

### Comparative Example 1

A three-dimensional structure was manufactured in the same manner as in Example 1, except that silica particles were not surface-treated with a silane coupling agent.

### Comparative Example 2

A three-dimensional structure was manufactured in the same manner as in Comparative Example 1, except that the configuration of the three-dimensional formation composition was changed as shown in Table 1 by changing the kinds of raw materials used in preparing the three-dimensional formation composition and the combination ratio of each of the components.

The configurations of the three-dimensional structures of Examples and Comparative Examples are summarized in Table 1. In Table 1, silica is expressed as “SiO₂”, calcium carbonate is expressed as “CaCO₃”, alumina is expressed as “Al₂O₃”, titanium oxide is expressed as “TiO₂”, polyvinyl pyrrolidone is expressed as “PVP”, polyvinyl alcohol is expressed as “PVA”, vinyltriethoxysilane is expressed as “VTE”, 3-acryloxypropyltrimethoxysilane is expressed as “APM”, 3-methacryloxypropyl methyldimethoxysilane is expressed as “MPM”, p-styryltrimethoxysilane is expressed as “STM”, and 3-isocyanatopropyltriethoxysilane is expressed as “IPT”.

TABLE 1

| | Three-dimensional formation composition | | | | | | | |
|---|---|---|---|---|---|---|---|---|
| | Particle | | | | Water-soluble resin | | Solvent | |
| | | Silane | Average | Content | | Content | | Content |
| | | coupling | particle | ratio | | ratio | | ratio |
| | Composition | agent | diameter (μm) | (mass %) | Composition | (mass %) | Kind | (mass %) |
| Ex. 1 | SiO₂ | VTE | 5.0 | 21.0 | PVP | 11.0 | H₂O | 68.0 |
| Ex. 2 | SiO₂ | APM | 5.0 | 17.0 | PVP | 13.0 | H₂O | 70.0 |
| Ex. 3 | SiO₂ | MPM | 5.0 | 16.0 | PVP | 16.0 | H₂O | 68.0 |
| Ex. 4 | SiO₂ | STM | 5.0 | 20.0 | PVP | 10.0 | H₂O | 70.0 |
| Ex. 5 | SiO₂ | IPT | 5.0 | 21.0 | PVP | 11.0 | H₂O | 68.0 |
| Ex. 6 | CaCo₃ | VTE | 5.0 | 58.0 | PVA | 5.0 | H₂O | 37.0 |
| Ex. 7 | Al₂O₃ | VTE | 5.0 | 58.5 | PVA | 5.0 | H₂O | 36.5 |
| Ex. 8 | TiO₂ | VTE | 5.0 | 57.8 | PVA | 4.5 | H₂O | 37.7 |
| Comp. | SiO₂ | — | 5.0 | 21.0 | PVP | 11.0 | H₂O | 68.0 |
| Ex. 1 | | | | | | | | |
| Comp. | SiO₂ | — | 5.0 | 58.0 | PVP | 5.0 | H₂O | 37.0 |
| Ex. 2 | | | | | | | | |

### [3] Evaluation

### [3.1] Tensile Strength and Tensile Elastic Modulus

The tensile strength and tensile elastic modulus of each of the three-dimensional structures A in Examples and Comparative Examples were measured under the conditions of a tensile yield stress of 50 mm/min and a tensile elastic modulus of 1 mm/min based on JIS K 7161: 1994 (ISO 527: 1993). The tensile strength and tensile elastic modulus thereof were evaluated based on the following criteria.

### Tensile Strength

A: tensile strength of 35 MPa or more

B: tensile strength of 30 MPa to less than 35 MPa

C: tensile strength of 20 MPa to less than 30 MPa

D: tensile strength of 10 MPa to less than 20 MPa

E: tensile strength of less than 10 MPa

### Tensile Elastic Modulus

A: tensile elastic modulus of 1.5 GPa or more

B: tensile elastic modulus of 1.3 GPa to less than 1.5 GPa

C: tensile elastic modulus of 1.1 GPa to less than 1.3 GPa

D: tensile elastic modulus of 0.9 GPa to less than 1.1 GPa

E: tensile elastic modulus of less than 0.9 GPa

### [3.2] Bending Strength and Bending Elastic Modulus

The bending strength and bending elastic modulus of each of the three-dimensional structures B of Examples and Comparative Examples were measured under the conditions of a distance between supporting points of 64 mm and a testing speed of 2 mm/min based on JIS K 7171: 1994 (ISO 178: 1993). The bending strength and bending elastic modulus thereof were evaluated based on the following criteria.

### Bending Strength

A: bending strength of 65 MPa or more

B: bending strength of 60 MPa to less than 65 MPa

C: bending strength of 45 MPa to less than 60 MPa

D: bending strength of 30 MPa to less than 45 MPa

E: bending strength of less than 30 MPa

### Bending Elastic Modulus

A: bending elastic modulus of 2.4 GPa or more

B: bending elastic modulus of 2.3 GPa to less than 2.4 GPa

C: bending elastic modulus of 2.2 GPa to less than 2.3 GPa

D: bending elastic modulus of 2.1 GPa to less than 2.2 GPa

E: bending elastic modulus of less than 2.1 GPa

These results are summarized in Table 2.

TABLE 2

| | | Tensile | | Bending |
|---|---|---|---|---|
| | Tensile | elastic | Bending | elastic |
| | strength | modulus | strength | modulus |
| Ex. 1 | A | A | A | A |
| Ex. 2 | A | A | A | A |
| Ex. 3 | A | A | A | A |
| Ex. 4 | A | A | A | A |
| Ex. 5 | A | A | A | A |
| Ex. 6 | B | B | B | A |
| Ex. 7 | B | A | B | A |
| Ex. 8 | B | A | B | A |
| Comp. Ex. 1 | C | D | D | D |
| Comp. Ex. 2 | E | E | E | E |

As apparent from Table 2, in the invention, three-dimensional structures having excellent mechanical strength were obtained. In contrast to this, in Comparative Examples, sufficient results were not obtained.

The entire disclosure of Japanese Patent Application No. 2014-090624, filed Apr. 24, 2014 is expressly incorporated by reference herein.

What is claimed is:

1. A method of manufacturing a three-dimensional structure, in which the three-dimensional structure is manufactured by laminating a layer, the method comprising:
forming the layer using a three-dimensional formation composition containing a particle whose surface is hydrophobically treated and has at least one reactive group selected from the group consisting of an acrylic group, a methacrylic group, a vinyl group, a styryl group, and an isocyanate group; and
discharging a curable ink containing monofunctional and/or difunctional (meth)acrylate onto the layer.

2. The method of manufacturing a three-dimensional structure according to claim 1,
wherein the reactive group of the surface of the particle is a functional group introduced by a silane coupling agent.

3. The method of manufacturing a three-dimensional structure according to claim 1,
wherein the particle is an inorganic particle.

4. The method of manufacturing a three-dimensional structure according to claim 1,
wherein the particle is made of any one selected from the group consisting of silica, calcium carbonate, alumina, and titanium dioxide.

5. The method of manufacturing a three-dimensional structure according to claim 1,
wherein the three-dimensional formation composition contains a water-soluble resin.

6. A three-dimensional structure, which is manufactured by the method of manufacturing a three-dimensional structure according to claim 1.

7. A three-dimensional structure, which is manufactured by the method of manufacturing a three-dimensional structure according to claim 2.

8. A three-dimensional structure, which is manufactured by the method of manufacturing a three-dimensional structure according to claim 3.

9. A three-dimensional structure, which is manufactured by the method of manufacturing a three-dimensional structure according to claim 4.

10. A three-dimensional structure, which is manufactured by the method of manufacturing a three-dimensional structure according to claim 5.

11. A three-dimensional structure manufacturing apparatus, in which the three-dimensional structure is manufactured by laminating a layer, the apparatus comprising:
a layer formation unit that forms the layer using a three-dimensional formation composition containing a particle whose surface is hydrophobically treated and has at least one reactive group selected from the group consisting of an acrylic group, a methacrylic group, a vinyl group, a styryl group, and an isocyanate group; and
an ink discharge unit that discharges a curable ink containing monofunctional and/or difunctional (meth)acrylate onto the layer.

12. A three-dimensional formation composition, comprising:
a particle whose surface is hydrophobically treated and has at least one reactive group selected from the group consisting of an acrylic group, a methacrylic group, a vinyl group, a styryl group, and an isocyanate group.

13. A three-dimensional formation material, comprising:
a three-dimensional formation composition containing a particle whose surface is hydrophobically treated and has at least one reactive group selected from the group consisting of an acrylic group, a methacrylic group, a vinyl group, a styryl group, and an isocyanate group; and
a curable ink containing monofunctional and/or difunctional (meth)acrylate.
